(19) United States
(12) Patent Application Publication
(10) Pub. No.: US 2008/0284616 A1
(43) Pub. Date: Nov. 20, 2008

(54) Quick return

(76) Inventor: Azael Flores Rendon, Apodaca (MX)

Correspondence Address: GRAYBEAL, JACKSON, HALEY LLP, 155 - 108TH AVENUE NE, SUITE 350, BELLEVUE, WA, 98004-5973, US

(21) Appl. No.: 12/150,604

(22) Filed: Apr. 28, 2008

Related U.S. Application Data
(63) Continuation-in-part of application No. PCT/MX2006/000117, filed on Oct. 26, 2006.

(30) Foreign Application Priority Data
Apr. 28, 2008 (MX) NL/A/2005/000085

(51) Int. Cl. G08G 1/095; E01C 1/02

(52) U.S. Cl. 340/907; 404/1

(57) ABSTRACT

A method for controlling traffic at an intersection which helps to avoid traffic jams at intersections by taking advantage of the free space ahead of the intersection and implementing an exclusive right return lane for the drivers wanting to make a left turn at the intersection in a very inexpensive way, thus minimizing traffic interruptions and raising the average velocity of the vehicles.

This is a continuation-in-part application that claims benefit, under 35 USC §120, of co-pending International Application PCT/MX2006/000117, filed on 26 Oct. 2006, designating the United States, which claims priority Mexican Patent Application No. NL/a/2005/000085, filed on 26 Oct. 2005, which application is incorporated herein by reference.

This invention, called “quick return”, arise by seeking to reduce the vehicular jam caused by the vehicles which have to turn to the left in lane intersections, which can be easily and economically implemented because it is carried out at the road surface, without the necessity of bridges nor undergrade crossing, resulting in a fluid traffic and making easy the traffic light synchronization, consequently saving time and fuel of the vehicle users and contributing to the environment improvement and increasing the city productivity.

### BACKGROUND

Person necessity to move by themselves or by means of their vehicles have been in evolution since the use of earthwork, stone, asphalt and concrete lanes and roads and, as the vehicle traffic has been increasing, the traffic has became more complex, giving rise to the implementation of vial means, regulations, signals, traffic lights, etc.

On engineering road design, the vehicle traffic is ordered and directed so as to lead the vehicle users to their destinations and a quickly and safety way. Said engineering roads have given result as several forms, such as grade crossings, traffic circles, clover-leaf intersections, undergrade crossing and nowadays the so called “English Turns”.

On an English Turn, to turn at the left (say at the west) on a green-light traffic light, the vehicle has to take the left lane, wait for the left green-light shaft and then crossing to the contrary lane and take the west lane, at the same time that vehicles transit longitudinally from the north to the south. However, to make this turn, it is required enough space, specific signalling, can cause confusion.

Furthermore, an English turn is suitable for facilitating the flow of traffic circulating approximately 500 mts. around the English Turn, since along the avenue there are used typical crossings.

In the quick return of the present invention, it is used to turn at the left (say to the west, coming from north-to-south). On the green light traffic light of an intersection, vehicles of both loans circulate continuously from north-south and south-north, then the vehicle which travels form north-to-south and wants to turn at the left (west), cross the intersection, taking a right lane which is exclusive to turn at the left and, on the green light shaft of an on-purpose traffic light, once the vehicle blocks have longitudinally passed, the vehicle can turn at the left, takes the right loan of the south-west way, reaches to the intersection and then turns to the right to the west as desired.

This quick return is different to other ways of turns (see U.S. Pat. No. 5,807,020; U.S. Pat. No. 5,520,478; U.S. Pat. No. 4,986,692; UEP 0980932; FR 700823; MX 149836) because it is implemented at the surface level and does not requires bridges nor undergrade crossings.

Thus resulting in benefits and advantages in its implementation, such as requiring a reduced space, it is simple and little complicated, and it is very economic because it is superficial, giving rise to an excellent functionality.

### BRIEF DESCRIPTION OF THE DRAWINGS

FIG. 1, shows a traffic circle;

FIG. 2, shows a so called clover-leaf intersection road engineering;

FIG. 3, shows the English Turn;

FIG. 4, shows two quick return systems on an avenue, one at each side of an intersection;

FIG. 5, is an aerial view of an avenue with several quick return systems (Nos. 1 and 13) at all-long showing the access to the right side the access to the left side (No. 15) and the turn at the left (No. 17) and a road crossing (No. 18).

FIG. 6, shows an approach to the avenue, showing a road crossing (No. 18), a signalizing (No. 19), an important avenue (No. 20) and a single street (No. 21).

FIG. 7, shows a quick return with a waiting vehicle (No. 2) within the exclusive loan (No. 3) with a synchronized flow from north-to-south and south-to-north (No. 4), with traffic lights (Nos. 5 and 7), the critic zone (No. 6), vehicles returning (Nos. 9 and 11); pedestrian pass (No. 10) and synchronized east-west west-east roads (No. 12);

FIG. 8, shows a typical intersection, with an in turn flow (No. 23), and the other ways stopped (No. 22);

FIG. 9, shows and identical view as FIG. 8, with a vehicle trying to change its loan (No. 24) because its loan is occupied by the other vehicles which wait to turn at the left;

FIG. 10, shows a quick return habilitating the four cardinal points and a left turn, at the four ways of the intersection. Showing the exclusive loan to return (No. 25) of a variable length as required;

FIG. 11, shows current possibilities for quick return in avenues of three, fourth and five loans, assigning one of them to return;

FIG. 12, shows a time-and-movement diagram of an avenue each three seconds (Nos. 26) with vehicles running at 60 Kpm running one kilometre in one minute without interruption, with a time of 40 seconds in the red light quick return (Nos. 1) and intersections (No. 18) showing the synchronized travelling of a vehicle block from south-to-north (No. 28) and the return of vehicles (Nos. 29) taking advantage of the non occupied space (No. 30) of the avenue, in order to return.

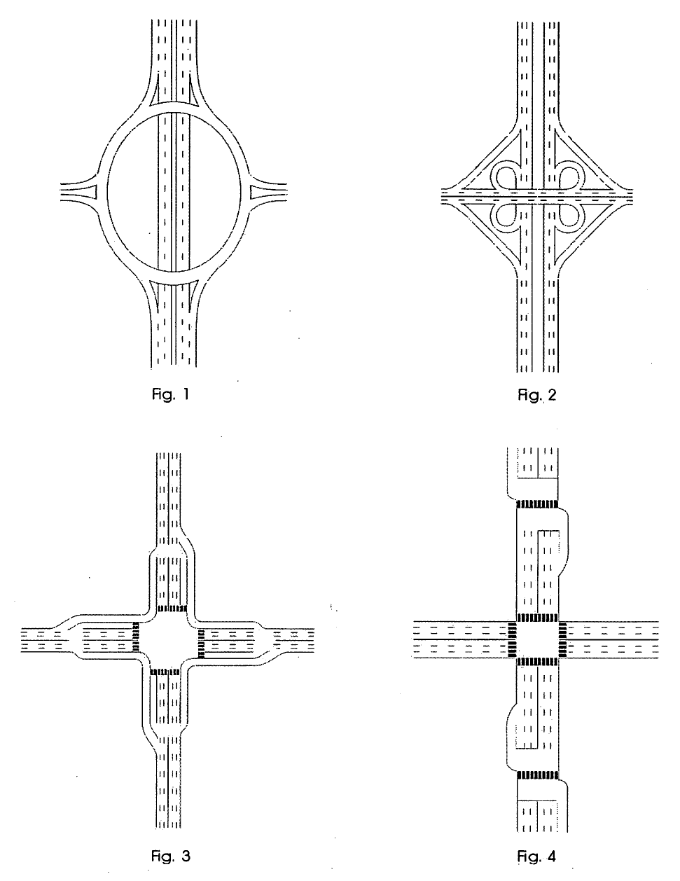

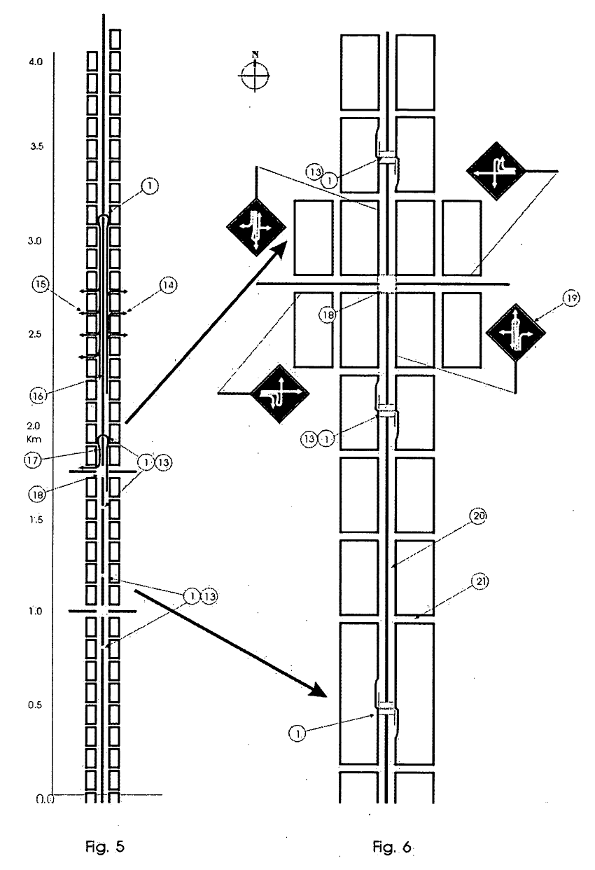

### DESCRIPTION OF THE INVENTION

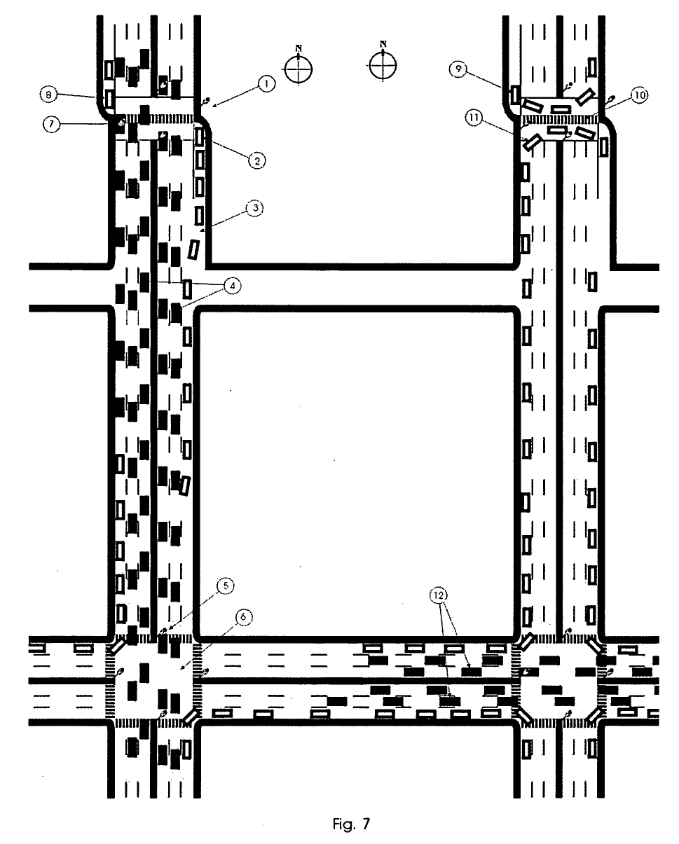

The present invention comprises the adequation of the vial infrastructure as shown in FIG. 7, (No. 1) which allows a driver driving from south to north to make a U-turn to the opposite street lanes without obstructing the lanes of the same street by crossing an intersection, taking an exclusive right return lane (No. 3), making the U-turn by crossing the street lanes on the green light shaft of an on-purpose traffic light, which turns on when the synchronized traffic going from south to north and from north to south (No. 4) completely pass, and incorporating to the opposite lane.

The FIG. 5, show several quick returns (Nos. 1) which are located at a distance of no more than 700 m from an intersection, thus allowing to implement several Quick returns without obstructing the street.

It is preferred to implement two quick returns at opposite way streets (No. 13) at a distance of between 150 to 300 m from an intersection (No. 18), since said quick returns allow the drivers circulating in the four ways, to make left turn, thus reducing traffic jams at intersections.

### DETAILED DESCRIPTION OF THE INVENTION

The present invention helps to avoid traffic jams at intersections by taking advantage of the free space ahead of the intersection and implementing an exclusive right return lane for the drivers wanting to make a left turn at the intersection in a very inexpensive way, (FIG. 7, No. 6), thus minimizing traffic interruptions and raising the average velocity of the vehicles. Therefore it has a micro impact since it facilitates the right turns and a macro impact since it minimize traffic jams and allow a continuous flow of traffic along the avenues.

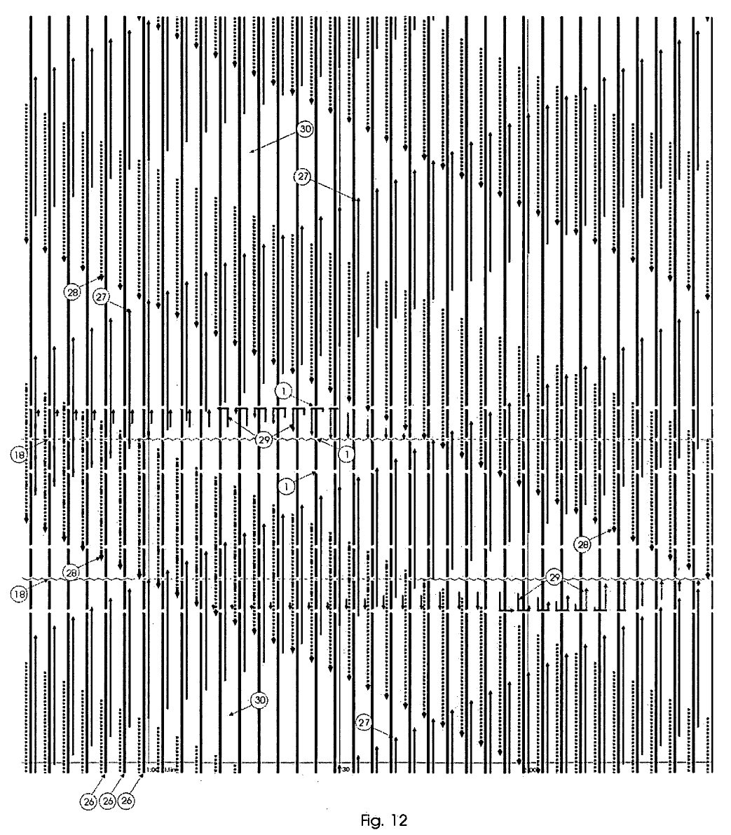

The quick return of the present invention is best implemented at non confined avenues having two ways and from two to five lanes each way (FIG. 11), controlled by traffic lights and a maximum velocity allowed of approximately 60 kph, and may be used by the drivers for several purposes.

The first typical main use of the quick return of the present invention is to make U-turns (FIG. 5, No. 16) or to access the left side of the avenue (No. 15). A second main use of the quick return of the present invention is to facilitate left turns at intersections (FIG. 10).

By implementing the quick return for the above referred main use it is achieved a better traffic fluidity and the longitudinal (FIG. 7, No. 4) and transversal (No. 12) synchrony of the avenues.

Furthermore, the quick return eliminates the necessity of having traffic lights for controlling left turns, and thus, it only has synchronized traffic lights for controlling the traffic along both longitudinal and transversal avenues in both ways, allowing the access to the opposite way lanes without interfering with the synchronized traffic flow in both ways of the avenue.

The exclusive right return lane may be comprised by one or two lanes (FIG. 11) having a variable length (FIG. 10 No. 25) depending on the characteristics and necessities of a specific intersection.

In some cases, there is no necessity for expanding the avenue in order to implement the right return lane. For example, in an avenue having five lanes each way, there may be used two lanes in each way as right return lanes and three lanes for the passing traffic.

In a north-south direction, for example, on green traffic lights, there is a continuous “longitudinal” flow of traffic (FIG. 7 No 11) and in the same direction, on red traffic lights there is a continuous east-west “transversal” flow of traffic (no. 12) thus allowing continuous flow and synchronization of the traffic.

At a quick return, on red traffic lights, it is allowed that the traffic waiting on the right return lane (FIG. 7 No. 11) to make a U-turn to the opposite way lanes while the traffic in both ways wait, and at the same time it allows pedestrians to cross the avenue (No. 10).

The location of a quick return depends on the average velocity planned for the circulating vehicles in the avenue, since there would be no additional traffic interruptions apart from the traffic lights on intersections of important avenues (80% of traffic) (FIG. 6 No. 20) and secondary streets (20% of traffic) (No. 21). In accordance with the present invention there would be intersections only between avenues having equal traffic volumes.

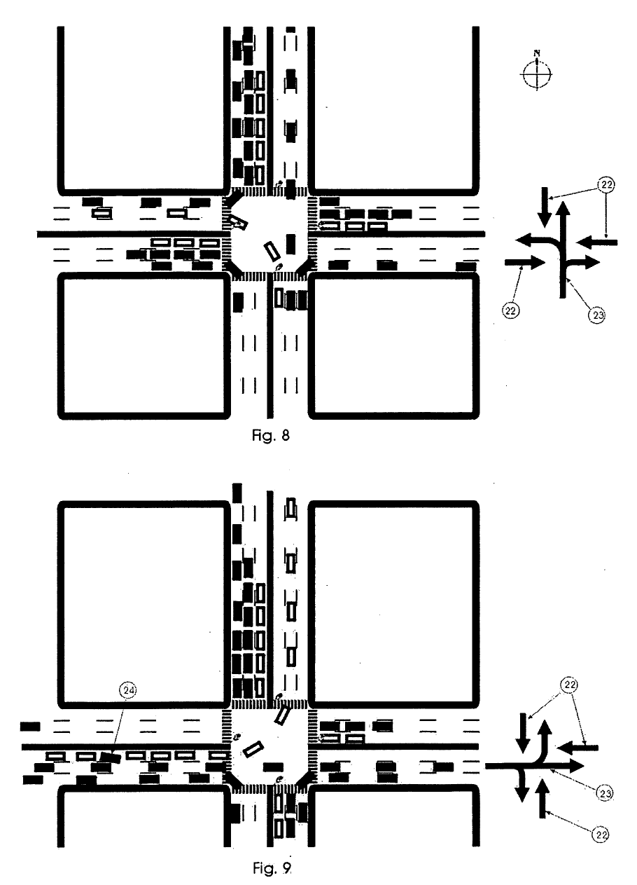

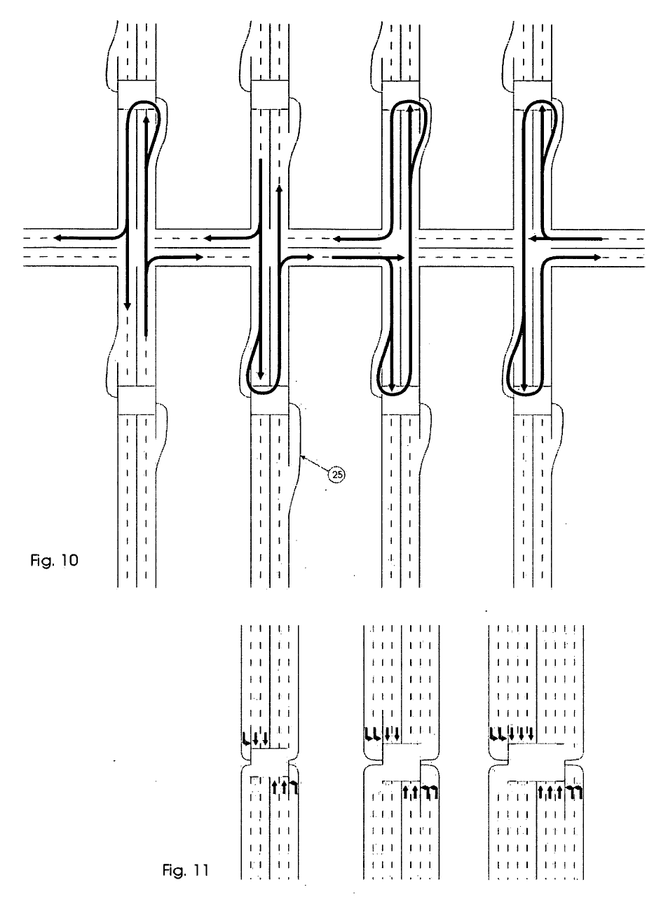

The quick return of the present invention maximizes the use of the critical area of the intersection (FIG. 7 No. 6) (vehicles per minute), since there would always be traffic circulating in both ways in each avenue: North-south, south-north and east-west, west east (FIG. 7 No. 4 and 12). By comparison, in a typical intersection, there is used only one quarter of its area (FIG. 8, FIG. 9) because only the traffic in one way is allowed to circulate, and the synchronization of traffic lights in such intersections is very complicated due to the different time cycles of each intersection.

In a typical left turn, a driver wanting to make a left turn (say to the west) (FIG. 8, FIG. 9 Nos. 23) should take the left lane and wait for a green light, thus obstructing said lane, which may be used by the vehicles circulating to the north. When the traffic light changes to green, all the traffic circulating in the other three ways (No. 22) should stop in order to allow said left lane to make the left turn (or u-turn if allowed).

The traffic light in a quick return only requires two lights (red and green) compared with one green light and three red lights for the vehicles circulating to the south, east and west needed for a typical left turn as described above.

By the implementation of two quick returns (one for each way) as shown in FIG. 10, left turns for the drivers circulating in the four ways are habilitated.

The implementation of one or more quick returns of the present invention facilitates the flow of traffic along one or two avenues (longitudinally or transversally) and does not require complicated infrastructure nor the construction of vehicle overpasses and underpasses.

Finally it must be understood that the quick return of the present invention, is not limited exclusively to the embodiments above described and illustrated and that the persons having ordinary skill in the art can, with the teaching provided by the invention, to make modifications to the quick return of present invention, which will clearly be within of the true inventive concept and of the scope of the invention which is claimed in the following claims.

What is claimed:

1. A method for controlling traffic at an intersection of a first and a second main road comprising multiple lanes in each direction for circulating vehicles, comprising:
providing at least one exclusive right lane for at least one direction of a road, said exclusive right lane located after passing the intersection, and said exclusive right lane ending on a pedestrian crossing;
providing a traffic light at said pedestrian crossing, including signals equivalent to “go” and “stop” for the exclusive right lane and signals equivalent to “go” and “stop” for the remaining lanes; and
providing the intersection with a traffic signal for each direction of each road, each traffic signal including signals equivalent to “go” and “stop”.

2. A method for controlling traffic at an intersection in accordance with claim 1, wherein the exclusive right lane is located at a distance of no more than 700 m from the intersection.

3. A method for controlling traffic at an intersection in accordance with claim 1, wherein the exclusive right lane is located at a distance of between 150 to 300 m from an intersection.

4. A method for controlling traffic at an intersection in accordance with claim 1, further comprising:
allowing vehicles circulating on the first main road to pass the intersection when the traffic signal indicates “go”;
allowing vehicles circulating on said first main road wanting to make a “u-turn” to take said exclusive right lane and wait at the traffic signal which indicates “stop”;
allowing the remaining vehicles circulating in the remaining lanes of the road to pass the pedestrian crossing and its traffic signal, which indicates “go”;
allowing the remaining vehicles circulating in the remaining lanes in both directions to stop at the “stop” signal behind the pedestrian crossing; and
allowing the vehicles waiting at the exclusive right lane to make the u-turn at the “go” signal”.

5. A method for controlling traffic at an intersection in accordance with claim 1, further comprising:
allowing vehicles circulating on the first main road to pass the intersection when the traffic signal indicates “go”;
allowing vehicles circulating on said first main road wanting to make a “u-turn” to take said exclusive right lane and wait at the traffic signal which indicates “stop”;
allowing the remaining vehicles circulating in the remaining lanes of said first main road to pass the pedestrian crossing and its traffic signal which indicates “go”;
allowing the remaining vehicles circulating in the remaining lanes in both directions of said first main road to stop at the “stop” traffic signal behind the pedestrian crossing;
allowing the vehicles waiting at the exclusive right lane to make the “u-turn” at the “go” signal”;
allowing the vehicles making the “u-turn” to incorporate to the right lanes of the contrary direction of said first main road;
allowing said vehicles to make a right turn and take the second main road.

6. A method for controlling traffic at an intersection in accordance with claim 1, further comprising:
allowing the vehicles circulating on said first main road to make a right turn an take the second main road if desired;
allowing vehicles circulating on the first main road to pass the intersection when the traffic signal indicates “go”;
allowing vehicles circulating on said main road wanting to make a “u-turn” to take said exclusive right lane and wait at the traffic signal which indicates “stop”;
allowing the remaining vehicles circulating in the remaining lanes of the road to pass the pedestrian crossing and traffic signal which indicates “go”;
allowing the remaining vehicles circulating in the remaining lanes in both directions to stop at the “stop” traffic signal behind the pedestrian crossing;
allowing the vehicles waiting at the exclusive right lane to make the “u-turn” at the “go” signal”;
allowing the vehicles making the “u-turn” to incorporate to the right lane of the contrary direction; and
allowing said vehicles to go straight and pass the intersection if desired.

7. A method for controlling traffic at an intersection in accordance with claim 5, in which when the traffic lights at the intersection, indicates “go” for both directions in said first main road and “stop” for both directions in said second road.

8. A method for controlling traffic at an intersection in accordance with claim 6, in which when the traffic lights at the intersection, indicates “go” for both directions in said first main road and “stop” for both directions in said second road.

9. A method for controlling traffic at an intersection in accordance with claim 4, wherein pedestrians are allowed to cross the pedestrian crossing when the traffic light at said pedestrian crossing indicates “stop” to both directions of a main street.

10. A method for controlling traffic at an intersection in accordance with claim 5, wherein pedestrians are allowed to cross the pedestrian crossing when the traffic light at said pedestrian crossing indicates “stop” to both directions of said first main street.

11. A method for controlling traffic at an intersection in accordance with claim 6, wherein pedestrians are allowed to cross the pedestrian crossing when the traffic light at said pedestrian crossing indicates “stop” to both directions of said first main street.

12. A method for controlling traffic at an intersection in accordance with claim 1, wherein the first and second main road each including a first and a second direction, wherein each direction of the first road has an exclusive right lane and wherein the method further including:
allowing the vehicles circulating on the first direction of the second main road to make a right turn in the intersection and take the first direction of said first main road;
allowing vehicles circulating on said first direction of said first main road wanting to make a “u-turn” to take said exclusive right lane and wait at the traffic signal which indicates “stop”;
allowing the remaining vehicles circulating in the remaining lanes of the first direction of said first main road to pass the pedestrian crossing and its traffic signal which indicates “go”;
allowing the remaining vehicles circulating in the remaining lanes of the first and second direction of said first main road to stop at the “stop” traffic signal behind the pedestrian crossing;
allowing the vehicles waiting at the exclusive right lane to make the “u-turn” at the “go” signal”;
allowing the vehicles making the “u-turn” to incorporate to the lanes of the second direction of said first main road;
allowing the vehicles circulating on said second direction of said first main road to cross the intersection and its traffic signal, which indicates “go” allowing vehicles circulating on said second direction of said first main road wanting to make a “u-turn” to take the exclusive right lane of said second direction of said first main road and wait at the traffic signal which indicates “stop”;
allowing the remaining vehicles circulating in the second direction of said first main road to pass the pedestrian crossing and traffic signal which indicates “go”;
allowing the remaining vehicles circulating in the remaining lanes in both directions of said first main road to stop at the “stop” traffic signal behind the pedestrian crossing;
allowing the vehicles waiting at the exclusive right lane of said second direction of said first main road to make the “u-turn” at the “go” signal”;
allowing the vehicles making the “u-turn” to incorporate to the first direction of said first main road; and
allowing said vehicles to make a right turn in the intersection and take the second direction of said second main road.
